(19) United States
(12) Patent Application Publication
(10) Pub. No.: US 2012/0196018 A1
(43) Pub. Date: Aug. 2, 2012

(54) Organic Compounds

(76) Inventors: Francisco Valentino Villagran, Mason, OH (US); Kimberley Gray, Loveland, OH (US); Rajesh Venkata Potineni, Cincinnati, OH (US)

(21) Appl. No.: 13/386,936

(22) PCT Filed: Jul. 29, 2010
(86) PCT No.: PCT/EP2010/061017

§ 371 Date: Feb. 24, 2012

Related U.S. Application Data
(60) Provisional application No. 61/229,308, filed on Jul. 29, 2009.

(51) Int. Cl. A23L 1/226; A23L 2/56

(52) U.S. Cl. 426/537; 426/538

(57) ABSTRACT

An orally-administrable product comprising an ingredient or ingredients that have associated with their use an unacceptable aftertaste, and a cooling compound employed as a taste-masking agent in an amount of 0.5 ppm or less.

This invention is concerned with compositions and methods related to taste masking. In particular, compositions and methods are provided related to reducing or eliminating unpleasant or unwanted tastes, e.g. after-tastes associated with orally-administrable products, in particular beverages.

Orally-administered products, particularly beverages, which contain artificial sweeteners, tannins, caffeine, vitamins or minerals, or herbal and botanical extracts or ingredients can have a distinctive and unacceptable after-taste. The after-taste of these products is variously described as metallic, acrid or bitter and the corresponding products can receive very low consumer acceptance as a result.

There are several known approaches to taste masking. A common problem is to provide taste-masking while avoiding the masking agents exerting an appreciable sensation that might detract from flavor accord sought by the flavorist. For such reason, highly flavored compounds or those exerting a significant physiological sensation in the mouth are not favoured.

Perhaps, the most common masker used throughout history has been sugar. This ingredient has been used to mask bitterness and sourness in many formulated foods.

Other taste-masking additives have been designed for specific applications.

Zinc salts have been utilized to inhibit sweetness and bitterness without affecting salt, savoury or sour tastes in food and oral care products. However, the attendant disadvantage of zinc salts is a lingering astringency.

2,4-Dihydroxynezoic acid and vanillyl amide can reduce the bitter taste of aqueous solutions containing caffeine. This blend can also reduce the bitterness of quinine and salicine.

US 2004/0197401 discloses a sulfated polysaccharide (i.e, carrageenan) to inhibit undesirable tastes in food, beverages and pharmaceuticals.

US 2003/0003212 discloses the use of chlorogenic acids (quinic acid, cinnamic acid) to mask bitter off-tastes and other displeasing tastes in foods.

U.S. Pat. No. 7,455,872 describes the use of taurine and 5′-nucleotide monophohpates to reduce the bitterness of KCl in food and beverages except on seafood or extracts of seafood.

There remains a need to provide effective taste-masking for orally-administrable products. In particular, there remains a need to provide effective taste-masking using ingredients that do not impart any appreciable flavor, taste or any other sensation that can adversely affect a flavorist's latitude in constructing a desired flavor accord.

Surprisingly, it has now been found that cooling compounds can be used to mask unpleasant tastes in orally-administrable products, such without exerting the physiological cooling sensation normally attendant with their use.

Cooling compounds typically elicit a cooling effect when employed in products in the order of hundred to thousands of ppm range. Even highly potent cooling compounds, such as those described in WO 2006/056087 are employed in orally-administrable products at levels of between 300 to 3000 ppm. It has now been found that a cooling sensation attendant with the use of such compounds can be reduced or eliminated and a taste-masking effect exerted when they are used in proportions significantly below those usually employed in orally-administrable products to provide a cooling effect.

In accordance with the present invention there is provided a method of eliminating or reducing after tastes attendant with the use of orally-administrable products comprising the step of incorporating into such products a cooling compound.

Many orally-administrable products would not benefit hedonically by exerting a cooling sensation and so, particularly in such cases, the cooling compounds may be used below their cooling threshold concentration.

By “cooling compound” is meant a chemical compound that exerts a cooling effect on the skin or the mucous membranes of the body. These compounds are commonly employed in foodstuffs, beverages, chewing gums, dentifrices, mouthwashes, medical products such as lotions, creams and salves, and personal care products. Examples of such compounds are the carboxamides described in WO 2006/056087. Other compounds that are cooling compounds as the term is used in the present invention are menthol, methyl lactate, TK-10, WS-3; WS-23 and those compounds described in WO 2005/049553 and WO 2007/019719.

Preferred cooling compounds useful in the present compositions and method are represented by the formula I

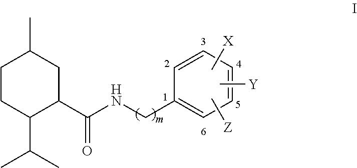

in which m is 0 or 1, Y and Z are selected independently from the group consisting of H, OH, C1-C4 straight or branched alkyl, and a C1-C4 straight or branched alkoxy; X is (CH₂)ₙ—R, where n is 0 or 1 and R is a group with non-bonding electrons, with the provisos that:
(a) when Y and Z are H, X is not F, OH, MeO or NO₂ in the 4-position and is not OH in the 2 or 6-position,
(b) when Y or Z is H then X, Y and Z are such that
   (i) the groups in the 3- and 4-positions are not both OMe,
   (ii) the groups in the 4- and 5-positions are not both OMe,
   (iii) the groups in 3- and 5-positions are not OMe if the group in the 4-position is OH, and
   (iv) the groups in the 3- and 5-positions are not OH if the group in the 4-position is methyl.

In certain embodiments, subject compounds are those in which X is in the 4-position. In some embodiments, subject compounds are those in which X is in the 4-position and Y and Z are H, OH, Me or OMe.

In certain embodiments, groups with non-bonding electrons are halogens, OH, OMe, NO₂, CN, Ac, SO₂NH₂, CHO, CO₂H and C1-C4 alkyl carboxylates such as CO₂Et.

A compound of one embodiment is 2-isopropyl-5-methyl-cyclohexanecarboxylic acid (4-cyanomethyl-phenyl)-amide, and still more particularly its stereoisomer (1 R,2S,5R)-N-(4-cyanomethyl-phenyl)-2-isopropyl-5-methylcyclohexanecarboxamide. This stereoisomer is known as Evercool 180. This compound and others according to the formula (I) above are further described in WO 2005/049553, which is incorporated herein by reference.

Further cooling compounds useful in the present compositions and methods are those represented by the following formula

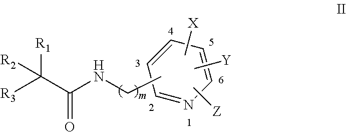

in which m is a number between 0 and 2; X, Y and Z are selected independently from the group consisting of I-I, halogen, OH, Me, Et, MeO and EtO; and R¹, R² and R³ together comprise at least 6 carbons, selected such that
(a) (i) R′ is selected from the group consisting of H, Me, Et, isopropyl and C₄-C₅ branched alkyl; and
   (ii) R² and R³ are independently selected from the group consisting of methyl, ethyl, isopropyl and C₄-branched alkyl; or
(b) any two or all of R¹, R² and R³ together form a monocyclic, bicyclic or tricyclic radical having up to 10 carbons.

As used in this specification, Me represents methyl, Et represents ethyl, and Ac represents acyl.

Examples of cyclic radicals as described under (b) above include 3-para-menthyl, bornyl and adamantyl.

The compounds may comprise one or more chiral centres and as such may exist as a mixture of stereoisomers, or they may be resolved as isomerically pure forms. If it is desired to prepare individual stereoisomers, this may be achieved according to methods known in the art, e.g. chiral HPLC and GC or by stereoselective syntheses.

In some embodiments, the compounds are those in which X, Y, Z are H, OH, Me or OMe. In certain embodiments, the compounds are those in which m is 2; X, Y and Z are H or Me; and R¹, R² and R³ are taken from Table 1.

TABLE 1
Exemplary R¹, R² and R³ groups.

| R¹ | R² | R³ |
|---|---|---|
| H | bornyl | |
| H | 3-p-menthyl | |
| H | isopropyl | isopropyl |
| methyl | isopropyl | isopropyl |
| ethyl | ethyl | ethyl |

adamantyl

A particularly effective compound is that in which R¹ is H and R² and R³ together form a 3-p-menthyl ring.

Examples of effective compounds are (1R,2S,5R)-2-isopropyl-5-methyl-N-(pyridinalkyl)cyclohexanecarboxamide and (2S,5R)-2-isopropyl-5-methyl-N-(pyridinalkyl)cyclohexanecarboxamide. Particular examples of these are (1R,2S,5R)-2-isopropyl-5-methyl-N-(2-(pyridin-4-yl)ethyl)cyclohexanecarboxamide and (2S,5R)-2-isopropyl-5-methyl-N-(2-(pyridin-4-yl)ethyl)cyclohexanecarboxamide.

A particularly preferred cooling compound useful in the present compositions and methods according to the formula (II) above is 2-isopropyl-5-methyl-cyclohexanecarboxylic acid (2-pyridin-2-yl-ethyl)-amide, and more particularly its stereoisomer (1R,2S,5R)-2-isopropyl-5-methyl-N-(2-(pyridin-2-yl)ethyl)cyclohexanecarboxamide. This compound is known as Evercool 190. This compound and others according to formula (II) above are further described in WO 2007/019719, which is incorporated herein by reference.

The quantity of cooling compound required to exert a taste-masking effect, optionally without an attendant cooling sensation, will vary depending on the nature of the cooling compound employed. The appropriate amount regarded as the minimum to exert a taste-masking effect and no cooling effect can easily be found for any compound by employing non-inventive routine experimentation using tasting panels. Generally, a cooling compound may be employed in orally administrable products in proportions of 0.5 ppm or less, more particularly less than about 0.1 ppm or less, still more particularly about 0.08 ppm or less, for example 0.5 to about 0.001 ppm, more particularly about 0.1 to about 0.001 ppm, still more particularly about 0.08 to about 0.001 ppm. When a combination of cooling compounds is employed, each cooling compound may be employed in the amounts mentioned above.

Orally-administrable products may contain one or more ingredients that have an unpleasant after-taste associated with their use. Such an after-taste may be described as being bitter, metallic or acrid. Ingredients known to have associated with their use an unpleasant after-taste include artificial sweeteners and other non-nutritive sweeteners. Artificial sweeteners include saccharin, aspartame, cyclamate, acesulfame K, sucralose and neotame. Non-nutritive sweeteners include stevia, thaumatin, Lo Han Guo and iso-malt. Functional ingredients and nutraceuticals can also cause off-notes or after-tastes, examples include caffeine, taurine, L-carnitine, tannins, gluconorolactone, certain vitamins and minerals, and salts found in sport drinks, energy drinks and the like.

In another aspect of the present compositions and methods, there is provided an orally-administrable product containing at least one ingredient that has associated with its use an unpleasant after taste and at least one cooling compound employed in the product.

In certain embodiments, the cooling compound or compounds can be employed in an amount of 0.5 ppm or less, more particularly about 0.1 ppm or less, still more particularly about 0.08 ppm or less, for example 0.5 to about 0.001 ppm, more particularly about 0.1 to about 0.001 ppm, still more particularly about 0.08 to about 0.001 ppm.

In yet another embodiment the ingredient or ingredients associated with the unpleasant after taste is selected from the group consisting of saccharin, aspartame, cyclamate, acesulfame K, sucralose and isomalt.

In yet another embodiment the cooling compound is selected from 2-Isopropyl-5-methyl-cyclohexanecarboxylic acid (4-cyanomethyl-phenyl)-amide, and more particularly the stereoisomer (1R,2S,5R)-N-(4-(cyanomethyl)phenyl)-2-isopropyl-5-methylcyclohexanecarboxamide, and 2-Isopropyl-5-methyl-cyclohexanecarboxylic acid (2-pyridin-2-yl-ethyl)-amide, and more particularly the stereoisomer (1R,2S,5R)-2-isopropyl-5-methyl-N-(2-(pyridin-2-yl)ethyl)cyclohexanecarboxamide.

By the term “orally-administrable product” as used herein is meant any solid or liquid composition that is consumed for at least one of nourishment and pleasure, or that is placed in the mouth to achieve an effect before being discarded. A broad general list includes, but is not limited to, foodstuffs of all kinds, confectionery, baked goods, sweet goods, dairy products and beverages.

The term “confectionery” includes, but is not limited to: chewing gum (which includes sugarized gum, sugar-free gum, functional gum and bubble gum), centerfill confections, chocolate and other chocolate confectionery, medicated confectionery, lozenges, tablets, pastilles, mints, standard mints, power mints, chewy candies, hard candies, boiled candies, breath and other oral care films or strips, candy canes, lollipops, gummies, jellies, fudge, caramel, hard and soft panned goods, toffee, taffy, liquorice, gelatin candies, gum drops, jelly beans, nougats, fondants, or combinations of one or more of these, or edible compositions incorporating one or more of these.

The term “baked goods” includes, but is not limited to: alfajores, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes.

The term “sweet goods” includes, but is not limited to: breakfast cereals, ready-to-eat (“rte”) cereals, family breakfast cereals, flakes, muesli, other rte cereals, children's breakfast cereals, hot cereals.

The term “dairy products” includes, but is not limited to: ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yogurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavored, functional and other condensed milk, flavored milk drinks, dairy only flavored milk drinks, flavored milk drinks with fruit juice, soy milk, sour milk drinks, fermented dairy drinks, coffee whiteners, powder milk, flavored powder milk drinks, cream, yogurt, plain/natural yogurt, flavored yogurt, fruited yogurt, probiotic yogurt, drinking yogurt, regular drinking yogurt, probiotic drinking yogurt, chilled and shelf-stable desserts, dairy-based desserts, soy-based desserts.

Other foodstuff includes, but is not limited to: chilled snacks, sweet and savory snacks, fruit snacks, chips/crisps, extruded snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, frozen pizza, chilled pizza, soup, canned soup, dehydrated soup, instant soup, chilled soup, uht soup, frozen soup, pasta, canned pasta, dried pasta, chilled/fresh pasta, noodles, plain noodles, instant noodles, cups/bowl instant noodles, pouch instant noodles, chilled noodles, snack noodles, dried food, dessert mixes, sauces, dressings and condiments, herbs and spices, spreads, jams and preserves, honey, chocolate spreads, nut-based spreads, and yeast-based spreads.

The term “beverage” as used herein means any drinkable liquid or semi-liquid, including for example: flavored water, soft drinks, fruit drinks, coffee-based drinks, tea-based drinks, juice-based drinks (includes fruit and vegetable), milk-based drinks, gel drinks, carbonated or non-carbonated drinks, powdered drinks, alcoholic or non-alcoholic drinks.

In the preparation of the abovementioned products, there may be used all or any of the standard ingredients found in such products, used in art-recognised quantities. Examples of such ingredients include (but are by no means limited to) solvents and co-solvents; surfactants and emulsifiers; viscosity and rheology modifiers; thickening and gelling agents; preservative materials; pigments, dyestuffs and colouring matters; extenders, fillers and reinforcing agents; stabilisers against the detrimental effects of heat and light; bulking agents; flavoring and flavor-enhancing agents; warming agents; breath fresheners; mouth moisteners; coloring agents; acidulants; buffering agents; antioxidants; or sweetening agents.

Specific examples of sweetening agents include, but are not limited to: sugar sweeteners (saccharide sweeteners), sugarless sweeteners, high-intensity sweeteners, or a combination of at least two of the foregoing sweetening agents.

Suitable bulking agents may include mineral adjuvants, which may serve as fillers and textural agents. Suitable mineral adjuvants include calcium carbonate, magnesium carbonate, alumina, aluminum hydroxide, aluminum silicate, talc, tricalcium phosphate, tricalcium phosphate and the like, which can serve as fillers and textural agents.

Additional bulking agents (carriers, extenders) suitable for use include sweetening agents such as monosaccharides, disaccharides, polysaccharides, sugar alcohols, polydextrose, and maltodextrins; minerals, such as calcium carbonate, talc, titanium dioxide, dicalcium phosphate; and combinations thereof.

Fillers modify the texture and aid processing. Examples of such fillers include magnesium and aluminum silicates, clay, alumina, talc, titanium oxide, cellulose polymers, and the like.

Specific examples of flavoring agents include, but are not limited to: natural flavors, artificial flavors, spices, seasonings, and the like. Exemplary flavoring agents include synthetic flavor oils and flavoring aromatics and/or oils, oleoresins, essences, distillates, and extracts derived from plants, leaves, flowers, fruits, and so forth, or a combination comprising at least one of the foregoing.

Exemplary flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, ume, cherry, raspberry, blackberry, tropical fruit, mango, mangosteen, pomegranate, papaya and so forth. Additional exemplary flavors imparted by a flavoring agent include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

In some embodiments, other flavoring agents including aldehydes and esters such as cinnamyl acetate, cinnamaldehyde, citral diethylacetal, dihydrocarvyl acetate, eugenyl 49 formate, p-methylamisol, and so forth can be used. Further examples of aldehyde flavorings include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modified, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like. Generally any flavoring or food additive such as those described in Chemicals Used in Food Processing, publication 1274, pages 63-258, by the National Academy of Sciences, can be used. This publication is incorporated herein by reference. Some of these additives may serve more than one purpose. For example, a sweetener, e.g., sucrose, sorbitol or other sugar alcohol, or combinations of the foregoing sweeteners, may also function as a bulking agent. A combination comprising at least one of the foregoing additives is often used.

There may additionally be present nutraceuticals and medicaments.

Suitable nutraceuticals may include, but are not limited to herbs and botanicals such as aloe, bilberry, bloodroot, calendula, capsicum, chamomile, cat's claw, echinacea, garlic, ginger, ginkgo, goldenseal, various ginseng, green tea, guarana, kava kava, lutein, nettle, passionflower, rosemary, saw palmetto, St. John's wort, thyme, and valerian. Also included are mineral supplements such as calcium, copper, iodine, iron, magnesium, manganese, molybdenum, phosphorous, zinc, and selenium. Other nutraceuticals may include fructooligosaccharides, glucosamine, grapeseed extract, cola extract, guarana, ephedra, inulin, phytosterols, phytochemicals, catechins, epicatechin, epicatechin gallate, epigallocatechin, epigallocatechin gallate, isoflavones, lecithin, lycopene, oligofructose, polyphenols, flavanoids, flavanols, flavonols, and psyllium as well as weight loss agents such as chromium picolinate and phenylpropanolamine. Exemplary vitamins and co-enzymes include water or fat soluble vitamins such as thiamin, riboflavin, nicotinic acid, pyridoxine, pantothenic acid, biotin, folic acid, flavin, choline, inositol and para-aminobenzoic acid, carnitine, vitamin C, vitamin D and its analogs, vitamin A and the carotenoids, retinoic acid, vitamin E, vitamin K, vitamin B6, and vitamin B12. Combinations comprising at least one of the foregoing nutraceuticals may be used.

Suitable medicaments may include oral care agents, throat care agents, allergy relief agents, and general medical care agents. General medical care agents may include antihistamines, decongestants (sympathomimetics), antitussives (cough suppressants), antiinflammatories, homeopathic agents, expectorants, anesthetics, demulcents, analgesics, anticholinergics, throat-soothing agents, antibacterial agents, antiviral agents, antifungal agents, antacids, antinauseants, chemotherapeutics, diuretics, psychotherapeutic agents, cardiovascular agents, various alkaloids, laxatives, appetite suppressants, ACE-inhibitors, anti-asthmatics, anti-cholesterolemics, antidepressants, anti-diarrhea preparations, anti-hypertensives, anti-lipid agents, acne drugs, amino acid preparations, anti-uricemic drugs, anabolic preparations, appetite stimulants, bone metabolism regulators, contraceptives, endometriosis management agents, enzymes, erectile dysfunction therapies such as sildenafil citrate, fertility agents, gastrointestinal agents, homeopathic remedies, hormones, motion sickness treatments, muscle relaxants. osteoporosis preparations, oxytocics, parasympatholytics, parasympathomimetics, prostaglandins, respiratory agents, sedatives, smoking cessation aids such as bromocriptine or nicotine, tremor preparations, urinary tract agents, anti-ulcer agents, anti-emetics, hyper- and hypoglycemic agents, thyroid and anti-thyroid preparations, terine relaxants, erythropoietic drugs, mucolytics, DNA and genetic modifying drugs, and nutritional supplements, including nutraceuticals, micronutrients, vitamins and co-enzymes. The pharmaceutically acceptable salts and prodrugs of the medicaments are also included unless specified otherwise. Some of these medicaments may serve more than one purpose. Combinations of the foregoing types of optional medicaments can be used. Two or more medicaments that have activity against the same or different symptoms can be used together in a combination.

Other suitable and desirable additives are described in standard texts, such as “Handbook of Industrial Chemical Additives”, ed. M. and I. Ash, 2^{nd} Ed., (Synapse 2000).

Some of the materials mentioned hereinabove may be present in encapsulated form. By “encapsulated form” is meant that the material is contained within an encapsulating material, which protects and/or retains it and permits its release either gradually or completely. All known methods of encapsulation, may be used, for example, coacervation, spray drying, and absorption into a porous substrate. All possible encapsulation materials may also be used, for example, natural fibres, minerals of large surface area and polymeric materials.

The subject compositions and methods are further described with reference to the following non-limiting examples.

### EXAMPLE 1

Masking aftertaste of aspartame, acesulfame K and sucralose in a commercial citrus flavored carbonated soft drink was investigated using a triangle test panel.

A commercial citrus flavored carbonated soft drink containing a blend of aspartame, acesulfame K and sucralose as sweeteners was selected to conduct a triangle test to evaluate the effect of cooling agents on the overall profile of the beverage.

A test sample consisted of a citrus flavored carbonated soft drink with 0.3 ppm of Evercool 180 and 0.3 ppm of Evercool 190. A control sample consisted of the pure citrus flavored carbonated soft drink.

Trained panellists were given three samples. In one iteration they were given two control samples and one test sample, and in another they were given two test samples and one control sample. The order of the samples and types of samples were selected at random.

The selected samples were presented to the panellist with the following instructions:

“Please taste the first sample, rinse with water, taste the second sample. Rinse with water and taste the third sample. Please circle the one sample that is different than the other two”.

The results indicated that eight out of eleven panellists choose the sample than was different from the other two, indicating that they were able to differentiate between the Control and Test samples.

These results were significant to a 99% probability level according to expanded statistical tables for estimating significance in paired; preference; paired; difference Duo, Trio and Triangle tests as set out in E. B. ROESSLER et al, Journal of Food Science, Volume 43, Issue 3, Pages 940-943, 1978 by the Institute of Food Technologists.

### EXAMPLE 2

Masking aftertaste of aspartame and acesulfame potassium in a commercial lemon-lime carbonated soft drink was investigated using a panel with an attribute scale.

A commercial lemon-lime flavored soft drink containing aspartame and acesulfame potassium as sweeteners was selected to conduct a sensory panel using a scale from 1 to 9 to rank changes in attributes against a reference product. The reference product was the commercial product with no additives. The test product was the commercial sample containing 0.2 ppm of Evercool 180 plus 0.2 ppm of Evercool 190.

The panellists were asked to test the reference sample and assign to this sample a value of 5 in a scale from 1 to 9 for the following attributes: Overall Flavor, Sweetness, Acidity, Bitterness, and Aftertaste. The panellists were requested to rinse their mouths with water and taste the following products:

Test sample (B), and

A control sample (A) (identical to the reference sample).

The panellists were asked to rinse their mouths with water in between samples. The test sample (B) and the reference (A) were randomly given to the panellists to evaluate and to assign a value to the attributes in the scale with respect to the reference (value=5). Values lower than 5 assigned to the test sample indicated lower aftertaste than reference, and values higher than 5 indicated higher aftertaste than the reference.

The average scores from 7 panellists showing the results from the sensory test are summarized in the following table.

| | Overall Flavor | | Sweetness | | Acidity | | Bitterness | | Aftertaste | |
|---|---|---|---|---|---|---|---|---|---|---|
| | A | B | A | B | A | B | A | B | A | B |
| Avg. | 5.4 | 5.2 | 5.2 | 4.9 | 4.8 | 4.8 | 5.0 | 4.1 | 4.7 | 3.8 |
| Score | | | | | | | | | | |

Results showed no significant difference between samples on the following attributes: Overall Flavor, Sweetness, and Acidity. However, there is significant difference in aftertaste with the sample containing the blend of Evercool 180 and Evercool 190 (test B) having less aftertaste than the sample without cooling compounds added (control A). In addition, sample containing the cooling compounds was considered to have lower bitterness.

### EXAMPLE 3

Masking bitterness in a commercial instant coffee was investigated.

A commercial instant coffee was selected to evaluate the effect of cooling compounds on the bitterness and aftertaste of the beverage using a scale from 1 to 9 to rank changes in attributes against a control product.

The control product was a 1% (w/w) solution of the instant coffee dissolved in hot water at 75° C. The test product was a 1% (w/w) solution of the instant coffee dissolved in hot water at 75° C. plus 0.4 ppm of Evercool 190.

The panellists were asked to test the reference samples and assign to this sample a value of 5 in a scale from 1 to 9 for the following attributes: Overall Flavor, Sweetness, Acidity, Bitterness, and Aftertaste. The panellists were requested to rinse their mouths with water and taste the following products:

Test sample (B), and

Control sample (A).

The panellists were asked to rinse their mouths with water in between samples. The test sample (B) and the control (A) were randomly given to the panellists to evaluate and to assign a value to the attributes in the scale with respect to a reference (value=5). For example: values lower than 5 assigned to the test sample will indicate lower bitterness than reference, and values higher than 5 will indicate higher bitterness than the reference.

The average scores from 8 panellists showing the results from the sensory test are summarized in the following table.

| | Overall Flavor | | Sweetness | | Acidity | | Bitterness | | Aftertaste | |
|---|---|---|---|---|---|---|---|---|---|---|
| | A | B | A | B | A | B | A | B | A | B |
| Avg. | 4.9 | 4.6 | 5.0 | 5.1 | 4.9 | 4.3 | 4.8 | 3.5 | 4.9 | 4.0 |
| Score | | | | | | | | | | |

Results showed no significant difference between samples on the following attributes: Overall Flavor, and Sweetness. Instant coffee containing Evercool 190 (sample B) displayed significantly lower bitterness than instant coffee without the addition of cooling compounds (sample A). The sample containing Evercool 190 also showed lower aftertaste, bitterness and directionally lower acidity than the instant coffee without cooling compounds added.

### EXAMPLE 4

Masking of Rebaudioside A aftertaste in a Flavored Ice Tea:

Raspberry Flavored Iced Tea

| | % |
|---|---|
| Water | 99.54 |
| Citric Acid | 0.1 |
| Sodium Benzoate | 0.025 |
| Potassium Sorbate | 0.015 |
| Tea Powder | 0.09 |
| Raspberry Flavor | 0.1 |
| Tea Flavor | 0.1 |
| Other Flavors | 0.0153 |
| Rebaudioside A (sweetener) | 0.02 |
| Evercool 180 | 0.05 ppm |

Panellists commented that the formulation was pleasant without bitterness or after taste.

### EXAMPLE 5

Reduction of Aftertaste of a Typical Energy Drink Formulation.

The following energy drink formulation was prepared:

| | % |
|---|---|
| Water (carbonated) | 86.723 |
| High Fructose Corn Syrup (55) | 12 |
| Citric Acid | 0.5 |
| Taurine | 0.25 |
| Citrus Flavors | 0.3 |
| Sodium Citrate | 0.085 |
| Sodium Benzoate | 0.08 |
| Caffeine | 0.03 |
| Carnitine | 0.006 |
| Niacinamide (Vit B3) | 0.0066 |
| Pyridoxine Hydrochloride (Vit B6) | 0.00037 |
| Evercool 180 | 0.2 ppm |
| Evercool 190 | 0.3 ppm |

Panellists considered the formulation to be pleasant-tasting without bitterness or after-taste.

Although the embodiments have been described in detail through the above description and the preceding examples, these examples are for the purpose of illustration only and it is understood that variations and modifications can be made by one skilled in the art without departing from the spirit and the scope of the disclosure. It should be understood that the embodiments described above are not only in the alternative, but can be combined.

1. A method of eliminating or reducing perceived after tastes attendant with the use of orally-administrable products comprising the step of incorporating into such products a compound, which is a cooling compound, in an amount that provides a taste-masking effect but does not exert a cooling sensation.

2. The method of claim 1 wherein the cooling compound is employed in an orally-administrable product in an amount of 0.5 ppm or less.

3. The method of claim 1 wherein the cooling compound is selected from the group consisting of 2-Isopropyl-5-methyl-cyclohexanecarboxylic acid (4-cyanomethyl-phenyl)-amide and 2-Isopropyl-5-methyl-cyclohexanecarboxylic acid (2-pyridin-2-yl-ethyl)-amide.

4. The method of claim 1 wherein the orally-administrable product contains at least one ingredient, the use of which has associated with it an unwanted or unpleasant taste or after-taste.

5. The method of claim 4 wherein the at least one ingredient is selected from the group consisting of artificial sweeteners, caffeine, tannins, and vitamins or minerals used in sports and energy drinks.

6. The method of claim 5 where the artificial sweetners include at least one of saccharin, aspartame, cyclamate, acesulfame K, sucralose or isomalt.

7. The method of claim 1 wherein the orally-administrable product is a beverage selected from the group consisting of low-calorie drinks, soft drinks, iced-tea, tea, instant coffee and brewed coffee.

8. An orally-administrable product containing at least one ingredient the use of which has associated with it an unwanted or unpleasant taste or after-taste, and a cooling compound present in an amount of 0.5 ppm or less.

9. The product of claim 8 wherein the cooling compound is selected from the group consisting of 2-Isopropyl-5-methyl-cyclohexanecarboxylic acid (4-cyanomethyl-phenyl)-amide and 2-Isopropyl-5-methyl-cyclohexanecarboxylic acid (2-pyridin-2-yl-ethyl)-amide.

10. The product of claim 8 wherein the ingredient or ingredients the use of which has associated with it an unwanted or unpleasant taste or after-taste is selected from the group consisting of artificial sweeteners, caffeine, tannins, and vitamins or minerals used in sports and energy drinks.

11. The product of claim 10 wherein the artificial sweeteners comprise at least one of saccharin, aspartame, cyclamate, acesulfame K, sucralose or isomalt.

12. The product of claim 8 wherein the product is a beverage.

13. The product of claim 12 wherein the product is a beverage selected from the group consisting of low-calorie drinks, soft drinks, iced-tea, tea, instant coffee and brewed coffee.

14.-15. (canceled)
